(19) United States
(12) Patent Application Publication
(10) Pub. No.: US 2010/0017467 A1
(43) Pub. Date: Jan. 21, 2010

(54) PROCESS MONITORING SYSTEM AND METHOD

(75) Inventor: TOSHIHISA FUJII, TOKYO (JP)

Correspondence Address: DARBY & DARBY P.C., P.O. BOX 770, Church Street Station, New York, NY, 10008-0770, US

(73) Assignee: YAMATAKE CORPORATION, TOKYO (JP)

(21) Appl. No.: 12/501,624

(22) Filed: Jul. 13, 2009

(30) Foreign Application Priority Data
Jul. 18, 2008 (JP) 2008-186943

(51) Int. Cl. G06F 15/16; G06F 17/30

(52) U.S. Cl. 709/203; 707/10

(57) ABSTRACT

To display process data so as to be easily understood even when operating when switching between daylight savings time and non-daylight savings time (standard time). A combination of detection times, using the first standard times, and process data are stored by a server device; the detection times of the historic data obtained from the server device are converted into second standard times and daylight savings times by a client terminal; and the process data are displayed on a screen in a time series based on the first standard times, the second standard times, or the daylight savings times; and both the second standard times and the daylight savings times, or one that is selected through an operation, are displayed on the screen together with the process data.

### CROSS REFERENCE TO PRIOR APPLICATIONS

The present application claims priority under 35 U.S.C. §119 to Japanese Patent Application No. 2008-186943, filed Jul. 18, 2008. The content of the application is incorporated herein by reference in its entirety.

### FIELD OF TECHNOLOGY

The present invention relates to a process monitoring technology, and, in particular, relates to a technology for displaying process data on a screen in operations wherein there is switching between daylight savings time and non-daylight savings time (standard time).

### BACKGROUND OF THE INVENTION

In process monitoring systems, when process data comprising various types of measurement values that indicate the state of a process, and various types of events that occur in the processes, collected from field devices through a server device, are displayed in a screen display of a client terminal, the measurement values and the events are displayed on the screen together with the times at which they were detected.

In this type of process monitoring system, time advances or delays occur when switching between daylight savings time and non-daylight savings time when there are operations that switch between daylight savings time and non-daylight savings time.

Conventionally, there have been proposals for methods for achieving synchronization of the times in the various devices within the system through generating internal times for all of the devices within the system based on signals that indicate a single standard time, for controlling the time when there are operations that switch between daylight savings time and non-daylight savings time. (See, for example, Japanese Unexamined Patent Application Publication 2003-322693).

Additionally, there are also proposals for methods to achieve synchronization of times in the various devices within a system through adjusting the advances and delays of times for individual clocks within each of the devices through sending, to each of the devices within the system, switching instructions from a single remote controlling device when switching between daylight savings time and non-daylight savings time. (See, for example, Japanese Unexamined Patent Application Publication 2006-200903).

In this type of conventional technology, times are synchronized by all of the devices that comprise the process monitoring system, and the detection times are controlled based on the synchronized times. Because of this, during the period of operation during daylight savings time, daylight savings times are displayed, and during the period of operations during non-daylight savings times, the adjusted times that indicate non-daylight savings times are used as the detection times.

Because of this, for intervals that bridge the time of switching between daylight savings time and non-daylight savings time, if a history of process data is displayed on a screen, then in the case that process data is displayed with one continuous time axis based on the detection times at which the process data were detected, then there would be temporal blank spaces or overlaps in the process data itself, which could cause the operator who is monitoring the process to have a misunderstanding.

FIG. 13 is a conventional example of a screen display of a trend graph when switching to daylight savings time. FIG. 13(a) illustrates historical data comprising a combination of detection times and process values, where detection times from non-daylight savings times are used in the historical data prior to the time point P for switching, and detection times of daylight savings times are used in the historical data after the time point P for switching.

Here an adjustment is made by advancing by one hour for the adjusted time used as the detection time at the time point P for switching from non-daylight savings time to daylight savings time. Because of this, as illustrated in FIG. 13(b), when displaying the process values on a screen as a trend graph with a single continuous time axis based on the detection times which comprise these adjusted times, a temporal blank space will be displayed at the point P of the time of switching from non-daylight savings time to daylight savings time.

FIG. 14 it is a conventional example of a screen display of a trend graph when switching to non-daylight savings time. FIG. 14(a) shows historical data comprising the detection times and the process values, where the historical data prior to the time point Q for switching uses detection times of daylight savings times, and the historical data after the switching point Q uses detection times of non-daylight savings times.

Here, at the time point Q for switching from daylight savings time to non-daylight savings time, an adjustment is performed to delay, by one hour, the adjusted time that is used as the detection time. Because of this, as illustrated in FIG. 14(b), when a trend graph of the process values is displayed on a screen using a single continuous time axis based on the detection times that are these adjusted times, there will be a temporal overlap at the time point Q for switching from daylight savings time to non-daylight savings time.

The object of the present invention is to provide a process monitoring system and method that solves these types of problems, to enable an easily understood screen display of process data even when operating when switching between daylight savings time and non-daylight savings time (standard time).

### SUMMARY OF THE INVENTION

In order to achieve this type of object, the process monitoring system as set forth in the present invention is a process monitoring system including a server device and a client terminal connected through a communications network, wherein process data collected from field devices by the server device are obtained by the client terminal through the communications network to be displayed on a screen, wherein: the server device has: a standard time clock portion for timing first standard times; a data receiving portion for receiving the process data from the field devices and for receiving the first standard times that indicate the detection times for the process data, from the standard time clock portion, and for storing historic data, comprising combinations of these process data and first standard times, into a historic database; and a data providing portion for reading out the historic data from the historic database and for providing notification to the client terminal through the communications network; and wherein: the client terminal includes: a data receiving portion for receiving the historic data through the communications network from the server device; a time controlling portion for converting the first standard times that are included in the historic data received by the data receiving portion into second standard times that are used by the client terminal, and for converting the second standard times into daylight savings times that are shifted by a specific amount of time; and a display controlling portion for displaying on a screen displaying portion the process data included in the historic data received by the data receiving portion based on the first standard times, or on the second standard times or daylight savings times that are converted by the time controlling portion, and for displaying both the second standard times and the daylight savings times, or one of these times that has been selected through an operation, on a screen together with the process data by the screen displaying portion.

At this time, when a time series of process values that include process data based on historical data is displayed on a screen in a graph by a display controlling portion, both a time axis of a second standard time and a time axis of daylight savings time, or either one, as selected through an operation, are/is displayed on the screen as the time axis/axes for the graph.

Additionally, when event data, included in the process data, in a time series on a screen based on historical data, are displayed by a display controlling portion, then both the second standard time and daylight savings time, or either, selected through an operation, may be displayed on the screen as the event occurrence times for the events.

Additionally, in the display controlling portion, an operating symbol for selecting either the second standard time or daylight savings time may be displayed on the screen together with the process data and the one that is selected by the operating symbol for the second standard time or daylight savings time may be displayed on the screen together with the process data.

Additionally, the process monitoring method according to the present invention is a process monitoring method having a server device and a client terminal connected through a communications network, wherein process data collected from field devices by the server device are obtained by the client terminal through the communications network to be displayed on a screen, wherein: the server device performs: a standard time clock step for timing first standard times; a data receiving step for receiving the process data from the field devices and for receiving the first standard times that indicate the detection times for the process data, from the standard time clock step, and for storing historic data, including combinations of these process data and first standard times, into a historic database; and a data providing step for reading out the historic data from the historic database and for providing notification to the client terminal through the communications network; and wherein: the client terminal performs: a data receiving step for receiving the historic data through the communications network from the server device; a time controlling step for converting the first standard times that are included in the historic data received by the data receiving step into second standard times that are used by the client terminal, and for converting the second standard times into daylight savings times that are shifted by a specific amount of time; and a display controlling step for displaying on a screen displaying portion the process data included in the historic data received by the data receiving step based on the first standard times, or on the second standard times or daylight savings times that are converted by the time controlling portion, and for displaying both the second standard times and the daylight savings times, or one of these times that has been selected through an operation, on a screen together with the process data by the screen displaying portion.

Given the present invention, there will be no temporal blank space or overlap in the display of the process data at the point in time of switching between daylight savings time and non-daylight savings time. As a result, in particular, in operations wherein there is switching between daylight savings time and non-daylight savings time (standard time), a screen display wherein the process data is easily understood is still possible, making it possible to prevent misunderstandings by the operator that performs the process monitoring.

### BRIEF DESCRIPTION OF THE DRAWINGS

FIG. 1 is a block diagram illustrating the structure of a process monitoring system as set forth in an embodiment according to the present invention.

FIG. 2 is a flowchart illustrating a data collecting process in a server device as set forth in the embodiment according to the present invention.

FIG. 3 is an example of the structure of the historic data.

FIG. 4 is a flowchart illustrating a process data displaying process in a client terminal as set forth in the embodiment according to the present invention.

FIG. 5 is an explanatory diagram illustrating a time converting process in the time controlling portion.

FIG. 6 is an example of a screen display of a trend graph at the time of switching to daylight savings time in the embodiment according to the present invention.

FIG. 7 is an example of a screen display of a trend graph at the time of switching to non-daylight savings time in the embodiment according to the present invention.

FIG. 8 is an example of a screen display of event data.

FIG. 9 is a flowchart illustrating the process data displaying process in a client terminal as set forth in another embodiment according to the present invention.

FIG. 10 is an example of a screen display of event data (non-daylight savings time) in another embodiment according to the present invention.

FIG. 11 is an example of a screen display of event data (daylight savings time) in the other embodiment according to the present invention.

FIGS. 12A and 12B are examples of a screen display of trend data as set forth in the other embodiment according to the present invention.

FIGS. 13A and 13B are examples of it a conventional screen display of trend data when switching to daylight savings time.

FIGS. 14A and 14B are examples of it a conventional screen display of trend data when switching to non-daylight savings time.

### DETAILED DESCRIPTION OF THE INVENTION

An embodiment according to the present invention will be explained next in reference to the figures.

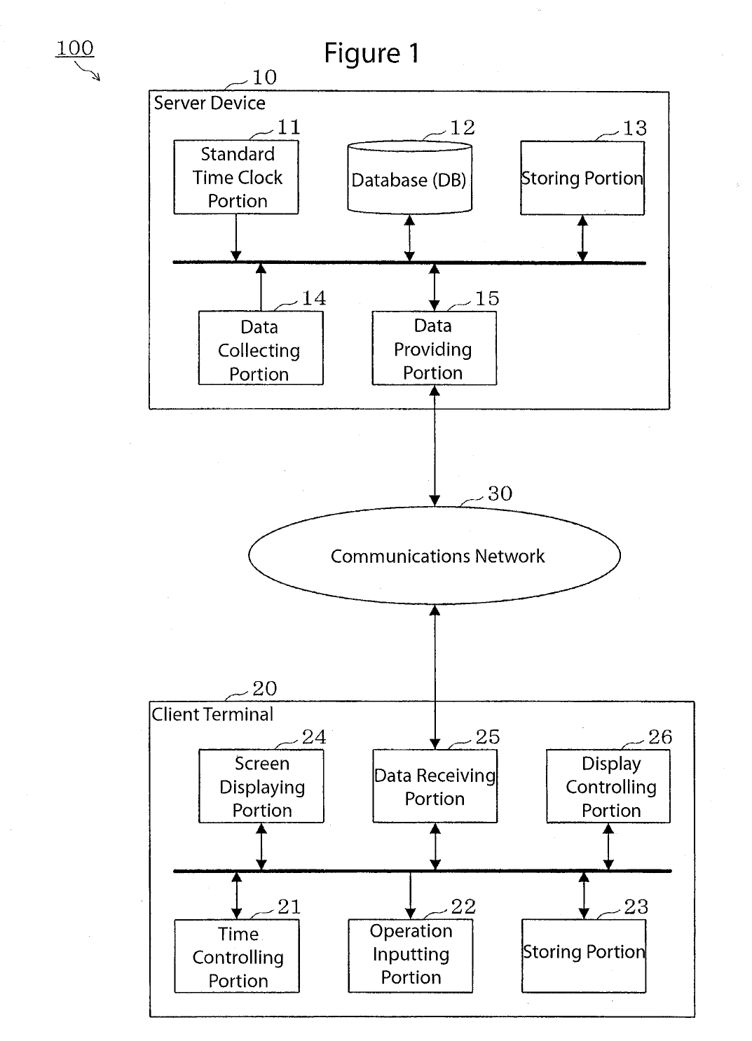

First, a process monitoring system according to an embodiment according to the present invention will be described in reference to FIG. 1. FIG. 1 is a block diagram illustrating the structure of a process monitoring system according to a first form of embodiment according to the present invention.

In various types of industrial plants, such as manufacturing plants, process monitoring systems for controlling process values such as temperature, fluid flow, pressure, concentrations, and the like are used for a variety of processes in order to perform automatic control of the process operating states.

In this type of process control system, not only are various types of process values controlled by field devices, but also the process values are measured and constantly monitored by the field devices, so that if there is a deviation from the normal range thereof that has been set in advance, then an alarm or message notification will be sent to an external device.

On the other hand, in order to perform process operations smoothly through these types of process control systems, process monitoring systems are used wherein operators monitor the process control systems.

In this type of process control system, notification event data such as, for example, data relating to various types of notification events such as alarms or messages that are produced in the process monitoring system, or process data, such as trend data (time series data) that show the changes over time in the process values obtained in the process control system, are collected automatically by the field devices in the process control system and displayed on a screen to provide notification to the operator.

This process monitoring system 100 includes a server device 10 and a client terminal 20 that are mutually connected through a communications network 30, where the process data that is collected from the process control system by the server device 10 is received by the client terminal 20, through the communications network 30, from the server device 10, to be displayed on a screen. At this time, if the process data is a process value, then the collection time, or if event data, then the occurrence time thereof, is displayed on the screen, as the detection time, together with the applicable process data.

In the present embodiment, a combination of detection times, which use first standard times, and process data are stored in the server device 10, and the detection times of the historic data obtained from the server device 10 are converted into second standard times, and into the daylight savings times thereof, by the client terminal 20, where not only is a time series displayed on the screen based on the first standard times, the second standard times, or daylight savings times, but also both the second standard times and daylight savings times, or either one that is selected by an operation, are displayed on the screen in addition to the process data.

### Structure of the Server Device

The structure of the server device 10 will be explained in detail in reference to FIG. 1 next.

The server device 10 has a data processing device such as a common workstation, server device, or personal computer. The server device 10 is provided with a standard time clock portion 11, a database portion 12, a storing portion 13, a data collecting portion 14, and a data providing portion 15, as the primary functional portions thereof, connected together via an internal bus.

The standard time clock portion 11 has a function that times a first standard time used in the server device 10 based on time synchronization signals that are obtained from a global positioning system (GPS) or a time server. The first standard time may be the Coordinated Universal Time (UTC), or may be the local standard time of the location in which the server device 10 is installed, or of another location, or may be a standard time having a predetermined time difference from the Coordinated Universal Time.

The historic database 12 includes a storage device such as a hard disk or a memory, and has the function for storing, as historic data, a combination of the process data obtained from the data collecting portion 14 and the detection times thereof.

The storing portion 13 has a storage device such as a hard disk or a memory, and has the function for storing various types of information and programs used in the processing operations by the data collecting portion 14 and the data providing portion 15.

The data collecting portion 14 has the function for collecting process data from external devices or field devices of the process control system, and a function for obtaining first standard times that indicate the process data collection times from the standard time clock portion 11, and for storing historic data, comprising a combination of these process data and the first standard times, into the historic database 12.

The data providing portion 15 has a function for reading out the historic data from the historic database 12 and providing notification to the client terminal 20 through the communications network 30.

In the server device 10, the standard time clock portion 11, the data collecting portion 14, and the data providing portion 15 may be embodied through controlling internal data communications functions provided in the server device 10 by a calculation processing portion through the cooperation between a CPU and a program.

### Structure of the Client Terminal

The structure of the client terminal 20 will be explained in detail next, in reference to FIG. 1.

The client terminal 20 includes an information processing terminal such as a common personal computer, PDA, mobile telephone terminal, or the like. The client terminal 20 is provided with a time controlling portion 21, an operation inputting portion 22, a storing portion 23, a screen displaying portion 24, a data receiving portion 25, and a display controlling portion 26 as the primary functions thereof, connected together through an internal bus.

The time controlling portion 21 has a function for converting a first standard time, which is the historic data received by the data receiving portion 25 from the server device 10, into a second standard time to be used by the client terminal, and a function for converting the second standard time into daylight savings time which has been shifted by a predetermined time.

The operation inputting portion has an operation inputting device, such as a keyboard, a mouse, or the like, and has a function for detecting an operation by the operator.

The storing portion 23 has a storage device, such as a hard disk or a memory, and has a function for storing the various types of processing data, such as historic data, and programs used in the processing operations by the time controlling portion 21, the data receiving portion 25, and the display controlling portion 26.

The screen displaying portion 24 includes a screen displaying device, such as an LCD or PDP, or the like, and has a function for displaying various types of data, such as process data for time data, on a screen in response to an instruction from the display controlling portion.

The data receiving portion 25 has a function for receiving historic data from a server device 10 through the communications network 30, and a function for storing the received historic data into the storing portion 23.

The display controlling portion 26 has a function for displaying the process data that is included in the historic data, obtained from the data receiving portion 25, on a screen using the screen displaying portion 24, in a time series, based on either the first standard times that are included in the historic data, or on the second standard times or daylight savings times converted by the time controlling portion, and a function for displaying on the screen, using the screen displaying portion 24, either both the second standard times and daylight savings times, or one or the other, selected through an operation, together with the process data.

The operation of the plant monitoring system according to the embodiment as set forth in the present invention will be explained next. Here the explanation will be for a case wherein the first standard times that are clocked by the server device 10 are of Coordinated Universal Time (UTC), and the second standard times that are used in the client terminal 20 are of Japan Standard Time (JST). Furthermore, it will be assumed that daylight savings time is a correction wherein Japan Standard Time is advanced by one hour (STM=JST+1:00). Here the operation of daylight savings time is assumed to be switching to daylight savings time from non-daylight savings time at 2 AM on Sunday, March 2 (the time point P for switching), and switching from daylight savings time to non-daylight savings time at 2 AM on the first Sunday of November (time point Q for switching).

### Operation of the Server Device

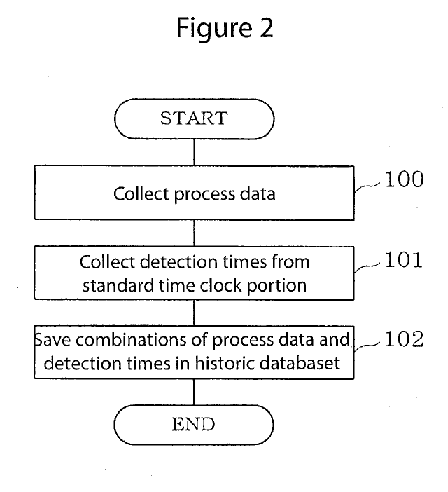

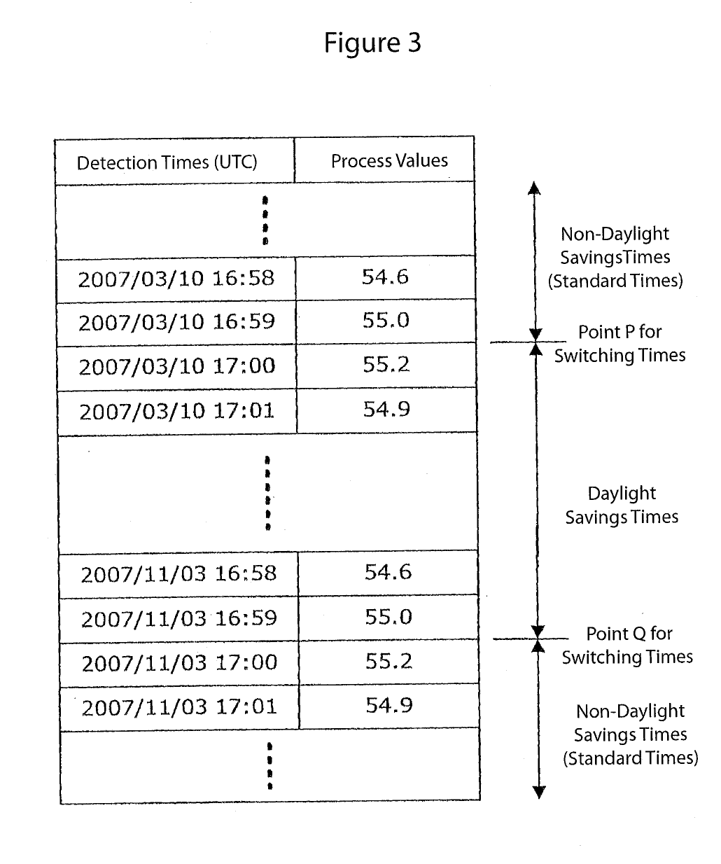

First the operation of the server device 10 will be explained in reference to FIG. 2 and FIG. 3. FIG. 2 is a flowchart illustrating the data collecting process by the server device as set forth in the present invention. FIG. 3 is an example of a structure for the historic data.

The data collecting portion 14 of the server device 10 constantly monitors the external devices and the field devices of the process control system and either collects process values at regular intervals or collects event data in accordance with notifications from the field devices or external devices (Step 100). Next the data collecting portion 14, when collecting process data such as process values and event data, obtains the first standard time from the standard time clock portion 11, in this case, the Coordinated Universal Time (UTC), as the detection clock (Step 101).

At this time, the first standard time is used, rather than an adjusted time wherein adjustments are made for daylight savings time/non-daylight savings time, and thus there will be no temporal open spaces or overlap in the detection time at the daylight savings time/non-daylight savings time time points P and Q for switching, as illustrated in FIG. 3.

Thereafter, the data collecting portion 14 saves, to the historic database 12, historic data that is a combination of the process data and the detection times (Step 102).

### Operation of the Client Terminal

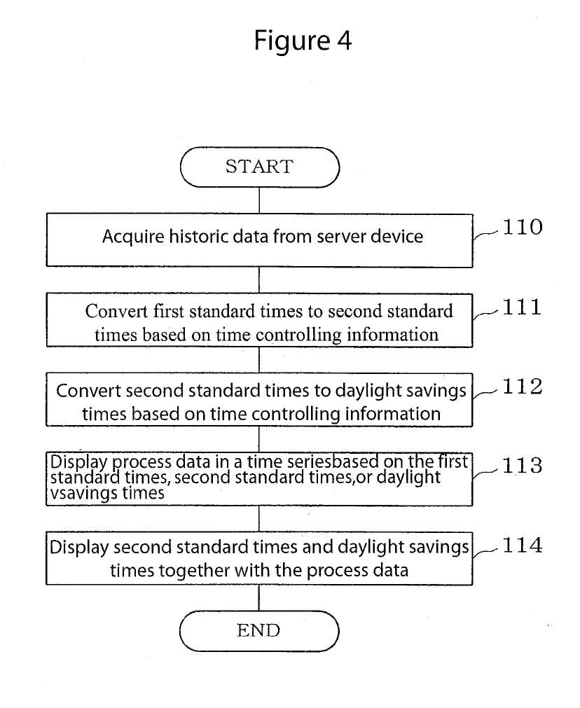

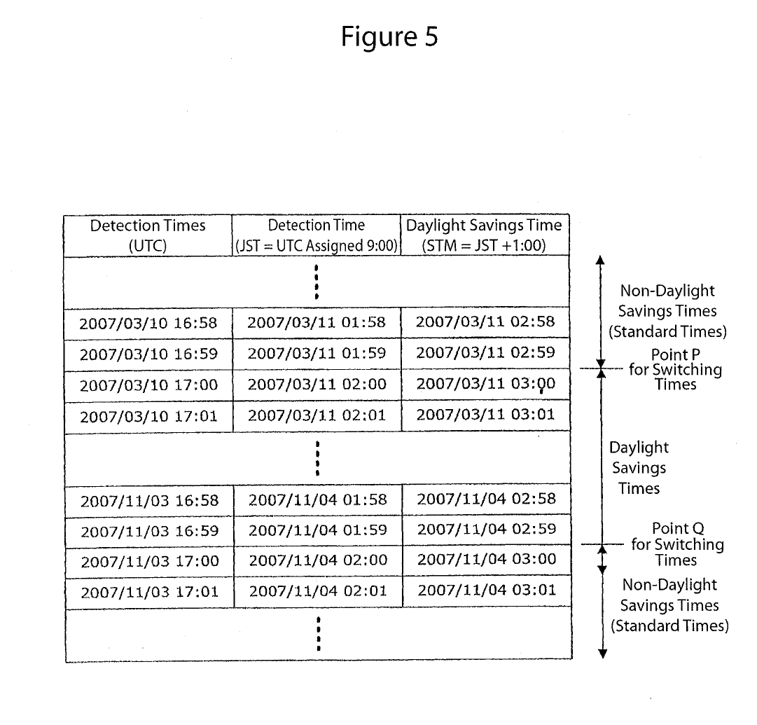

The operation of the client terminal 20 will be explained next in reference to FIG. 4 and FIG. 5. FIG. 4 is a flowchart illustrating the process data displaying process on the client terminal as set forth in claim 1 according to the present invention. FIG. 5 is an explanatory diagram illustrating the time converting process in the time controlling portion.

The data receiving portion 25 of the client terminal 20 obtains, and stores in the storing portion 23, the historic data that is stored in the historic database 12 of the server device 10 through performing data communications with the data providing portion 15 of the server device 10 through the communications network 30 in response to an operator operation detected by the operation inputting portion 22, or periodically, or in response to a notification from the server device 10 (Step 110).

The time controlling portion 21 reads out, from the storing portion 23, the historic data obtained from the server device 10 through the data receiving portion 25, and not only converts each individual detection time, which comprise the first standard times included in the individual historic data, into detection times that comprise the second standard times (Step 111), but also convert the detection times that comprise the second standard times into daylight savings times (Step 112).

Because there is a constant standard time difference between the first standard time and the second standard time, this standard time difference is stored in advance into the storing portion 23 as time controlling information. In the present example, the first standard time is the Coordinated Universal Time (UTC) and the second standard time is Japan Standard Time (JST), and so the standard time differential is +9 hours. Consequently, in the present example, the standard time differential is +9 hours, and thus the detection times comprising the second standard times (JST) are calculated by JST=UTC+9:00. Note that the first standard times may be the same standard time as the second standard times, in which case processing may be performed with the standard time differential=0, or the first standard times may be used as-is as the second standard times.

Furthermore, the daylight savings time differential between daylight savings times and non-daylight savings times is stored in advance as time controlling information in the storing portion 23. In the present example, the daylight savings time differential is +1 hours, and so daylight savings times (STM) are calculated as STM=JST+1:00.

Consequently, as illustrated in FIG. 5, in the time controlling portion 21, each of the detection times (UTC) in the historic data are converted into the respective second standard times (JST) and into daylight savings times (STM).

The display controlling portion 26 reads out the historic data that has been obtained from the server device 10 by the data receiving portion 25 and performs a screen display, on the screen displaying portion 24, of the process data included in the historic data in a time series based on the first standard times that are included in the historic data, the second standard times at that have been converted by the time controlling portion 21, or on daylight savings times (Step 113), and adds to the process data both a time axis comprising the second standard times and a time axis comprising the daylight savings times (Step 114).

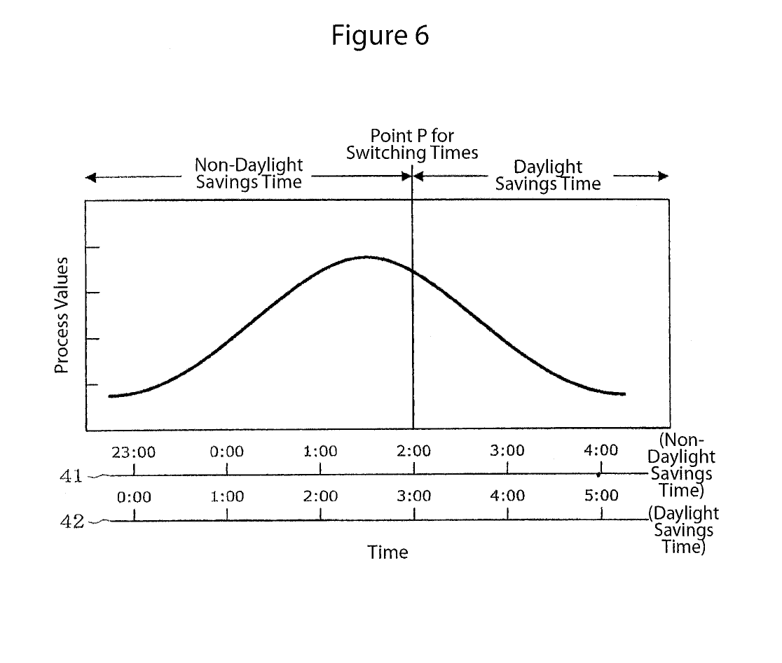

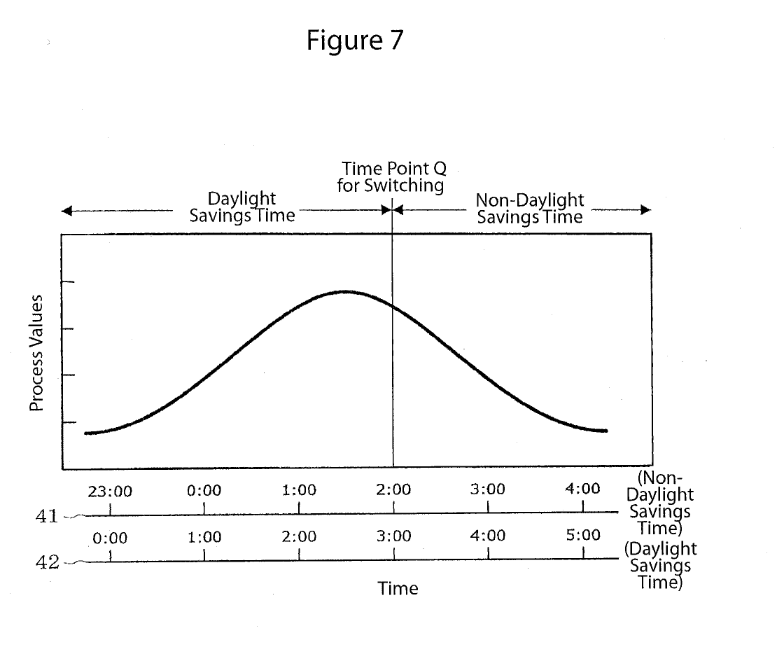

FIG. 6 is an example screen display of a trend graph at the time of switching to daylight savings time according to a first form of embodiment as set forth in the present invention. FIG. 7 is an example screen display of a trend graph at the time of switching to non-daylight savings time according to an embodiment as set forth in the present invention.

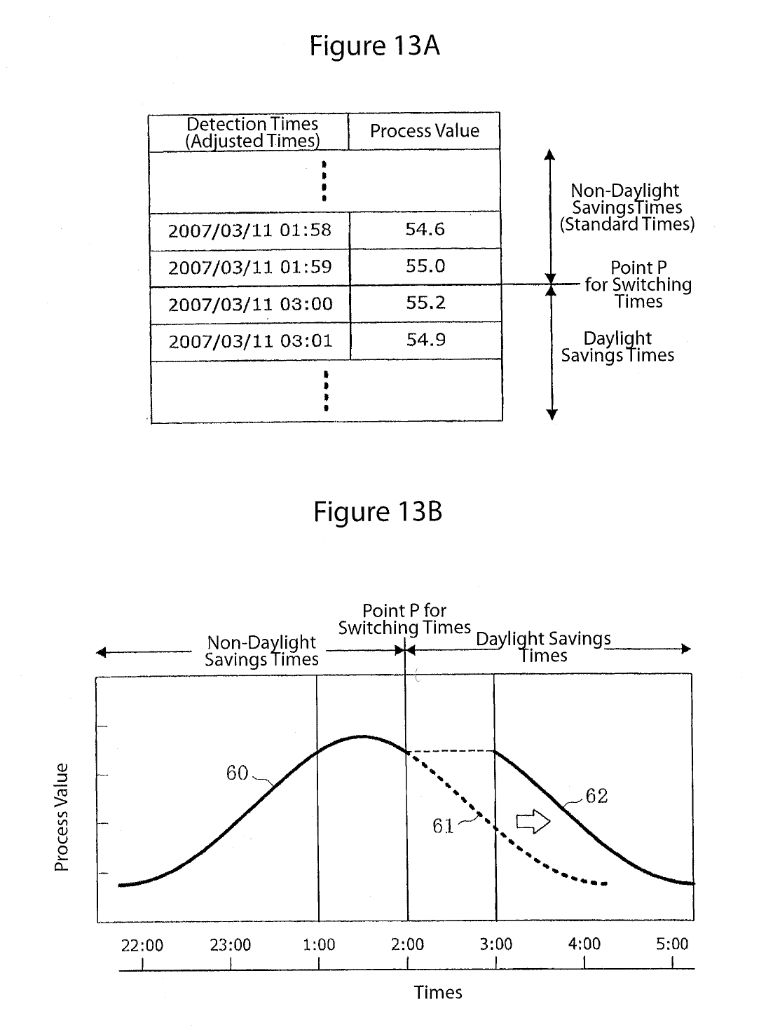

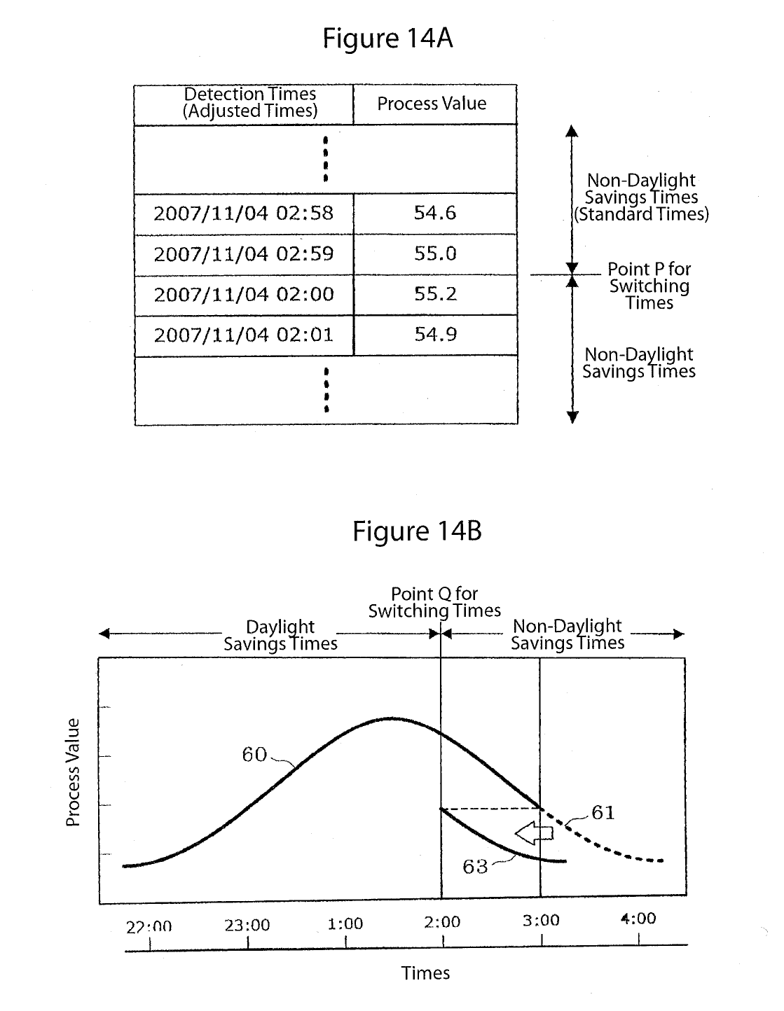

In the display controlling portion 26, the process values are displayed in a time series based on the first standard times, the second standard times, or daylight savings times, without adjusting the time by applying an adjustment between daylight savings times and non-daylight savings times. Because of this, in FIG. 6 and FIG. 7 there are no open spaces or overlapping portions in the trend graphs, in contrast to the case of displaying a time sequence on the screen using the adjusted times, as illustrated in FIG. 13(b) and FIG. 14(b).

Additionally, in the examples of screen displays in FIG. 6 and FIG. 7, a screen is displayed on the screen displaying portion 24 wherein both a time axis 41, comprising the second standard times, and a time axis 42, comprising the daylight savings times, are displayed in addition to the process data. Doing so prevents misunderstandings of the time axis between daylight savings time and non-daylight savings time.

In this way, in the present form of embodiment, the historic data, which is a combination of the detection times using the first standard times and the process data, is stored by the server device 10, and the detection times of the historic data, obtained from the server device 10, are converted into the second standard times and daylight savings times by the client terminal 20, and time sequences are displayed on the screen based on one of these times, either the first standard times, the second standard times, or the daylight savings times, and both the second standard times and the daylight savings times, or one of the two of them, selected through an operation, are displayed on the screen in addition to the process data.

More specifically, when the process data comprise time series data of process values, then when displaying, as a graph, the changes over time in the process values that are included in the process data, based on the historic data, both a time axis consisting of the second standard times and a time axis consisting of the daylight savings times are displayed on the screen as time axes for the graph.

Because of this, in contrast to the case wherein a time series is displayed on the screen using the adjusted times, there will be no temporal blank spaces or overlapping in the display of the process data at the points in time P and Q wherein there is switching between daylight savings times and non-daylight savings times. Consequently, in the case of operations wherein there is switching, in particular, between daylight savings times and non-daylight savings times (standard times), the process data will be displayed on the screen in an easily understood manner, making it possible to prevent misunderstanding by the operator who is performing the process monitoring.

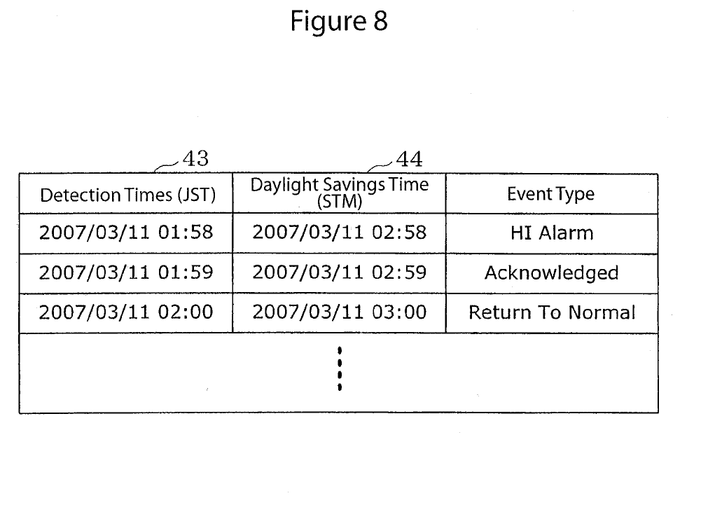

Additionally, while, in the present form of embodiment, the case wherein the process data consisted of time series data of process values was explained as an example, the type of process data is not limited thereto, but rather may be event data. FIG. 8 is an example of a screen display for event data. Normally, when the event data is displayed in a time series, the screen is displayed in the form of a table, as illustrated in FIG. 8. Consequently, both the second standard times 43 and the daylight savings times 44, in accordance with the first standard times, may be displayed on the screen in addition to the individual event data as the detection times for each event data, by the display controlling portion 26.

A process monitoring system according to another embodiment as set forth in the present invention will be explained next.

In the previous embodiment a case was explained wherein both the second standard times and the daylight savings times were displayed on the screen in addition to the process data. In the present form of embodiment, a case will be explained wherein the second standard times or the daylight savings times, selected through an operation, will be displayed on the screen in addition to the process data.

The display controlling portion 26 of the client terminal 20 in the present form of embodiment has a function for displaying on a screen either the second standard times or the daylight savings times corresponding to the first standard times included in the historic data, together with the process data, a function for displaying on the screen, together with the process data, an operating symbol for selecting either the second standard times or the daylight savings times, and a function for displaying on the screen, together with the process data, the second standard times or the daylight savings times, selected using the operating symbol.

The other constituents of the server device 10 and the client terminal 20 in the present form of embodiment are identical to those of the above embodiment, and detailed explanations are omitted herein.

The operation of the plant monitoring system according to another embodiment as set forth in the present invention will be described next. Here the explanation will be for the case wherein the process data is event data. Note that the operation of the server device is identical to that in the previous embodiment, and detailed explanations thereof are omitted here.

### Operation of the Client Terminal

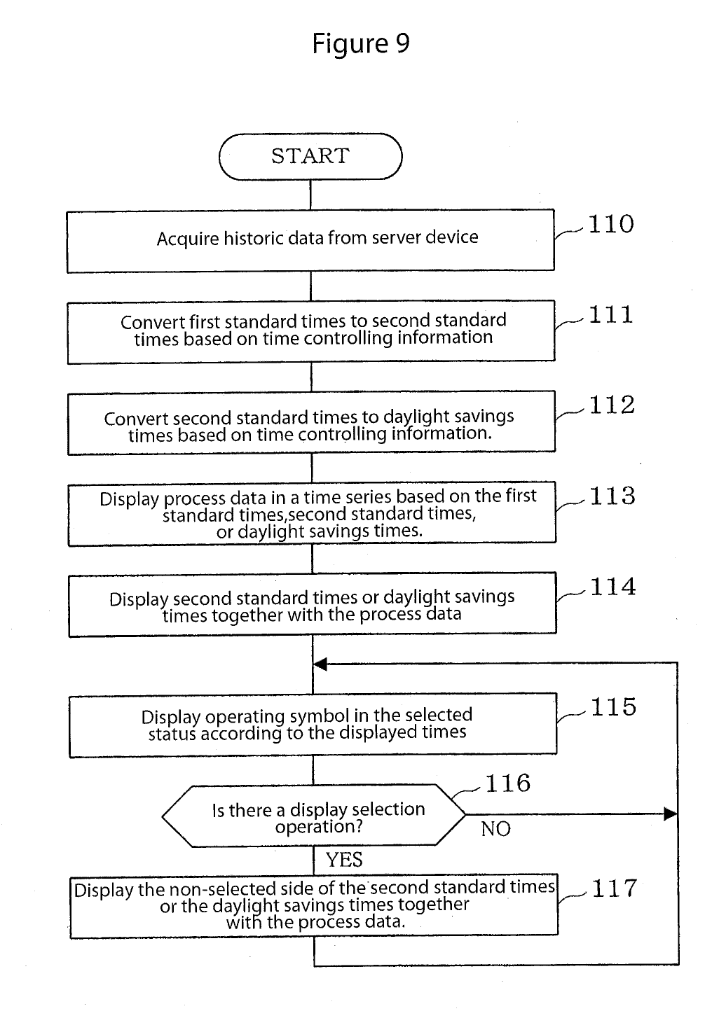

The operation of the client terminal 20 will be explained in reference to FIG. 9. FIG. 9 is a flowchart illustrating the process data display process in the client terminal as set forth in another embodiment according to the present invention.

The data receiving portion 25 of the client terminal 20 obtains, and stores in the storing portion 23, the historic data that is stored in the historic database 12 of the server device 10 through performing data communications with the data providing portion 15 of the server device 10 through the communications network 30 in response to an operator operation detected by the operation inputting portion 22, or periodically, or in response to a notification from the server device 10 (Step 110).

The time controlling portion 21 reads out, from the storing portion 23, the historic data obtained from the server device 10 through the data receiving portion 25, and not only converts each individual detection time, which comprise the first standard times included in the individual historic data, into detection times that comprise the second standard times (Step 111), but also convert the detection times that comprise the second standard times into daylight savings times (Step 112). The details of the time conversion are identical to those in the above embodiment.

The display controlling portion 26 reads out the historic data that has been obtained from the server device 10 by the data receiving portion 25 and performs a screen display, on the screen displaying portion 24, of the process data included in the historic data in a time series based on the first standard times that are included in the historic data, the second standard times at that have been converted by the time controlling portion 21, or on daylight savings times (Step 113).

Next the displaying portion displays a screen, using the screen displaying portion 24, wherein either the second standard times or the daylight savings times are added to the process data (Step 114). At this time, of the second standard times and the daylight savings times, the times that are displayed initially (by default) are stored in advance in the storing portion 23 as display controlling data. The display controlling portion 26, in Step 114, selects either the second standard times or the daylight savings times, based on the content of the display controlling data read out from the storing portion 23 and displays a screen wherein these times are added to the process data. Here the second standard times (non-daylight savings times) are displayed by default.

Following this, the display controlling portion 26 displays a screen with an operating symbol 50 for selecting either the second standard times or daylight savings times, together with the process data (Step 115). As the operating symbol 50, a symbol such as, for example, a checkbox or a radio button, or the like, which is used commonly in a CGI (Common Gateway Interface) such as, for example, HTML (Hypertext Markup Language) may be used.

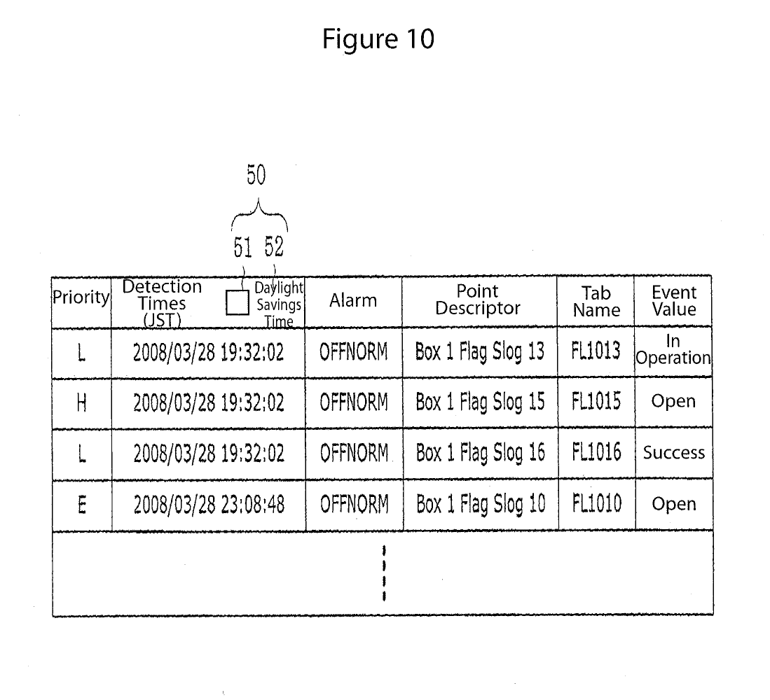

FIG. 10 is an example of a screen display for event data (non-daylight savings time) as set forth in the second example of embodiment according to the present invention. In this example, a checkbox in the form of “[CHECKBOX SYMBOL” [symbol] ] Daylight Savings Time” is displayed in the title field of the detection times as the operating symbol.

The operating symbol 50 is provided with a status displaying symbol 51, such as a checkmark or a black circle, or the like, that indicates the operating status of the operating symbol, and a caption 52 that is text data indicating the details of the operation of the operating symbol. The display controlling portion 26 displays, on the screen, whether the time that is currently displayed on the screen is daylight savings time or non-daylight savings time through controlling the switching of the display content of the status displaying symbol 51 based on the content of the caption 52 and on the state of selection of either the second standard times or the daylight savings times selected and displayed in Step 114.

For example, in FIG. 10 the caption 52 of the operating symbol 50 is “Daylight Savings Time,” and non-daylight savings times are selected and displayed as the default display, and so, as the status displaying symbol 51 of the operating symbol 50, the non-selected state wherein there is no added checkmark or black circle is displayed on the screen. Doing so makes it possible for the operator to discern with ease that the time that is currently displayed is non-daylight savings time because the non-selected state is displayed on the screen as the status displaying symbol 51 of the operating symbol 50.

Thereafter, the procedure moves to awaiting a display selecting operation using the operating symbol 50 (Step 116). Here, when a display selecting operation is performed using the operating symbol 50 by the operator using the mouse, or the like, of the operation inputting portion 22 (Step 116: YES), then the display controlling portion 26 displays a screen wherein the other currently non-displayed status of either the second standard times or the daylight savings times is displayed together with the process data (Step 117).

Following this, processing returns to Step 115, and the display controlling portion 26 displays a screen wherein an operating symbol 50, for selecting the times in accordance with the times selected and displayed in Step 117, is displayed on the screen together with the process data (Step 115).

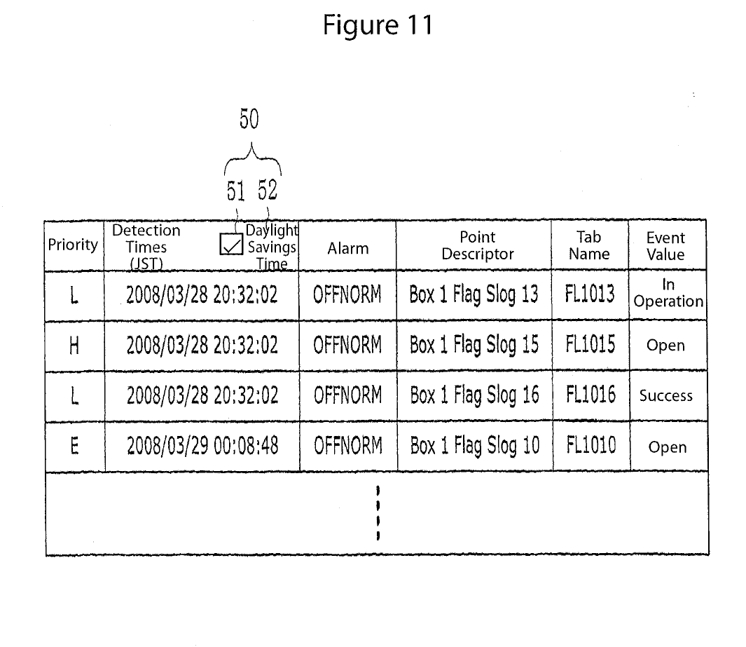

Consequently, after non-daylight savings time has been selected and displayed as the default display, if the display selecting operation is performed using the operating symbol 50, then daylight savings times will be displayed on the screen together with the process data. FIG. 11 is an example of a screen display of event data (daylight savings time) as set forth in the second form of embodiment according to the present invention. In this example, a checkmark or black circle is added as the status displaying symbol 51 for the checkbox that is displayed on the screen as the operating symbol 50 in the title field of the detection times. Doing so makes it possible for the operator to discern with ease that the currently displayed times are daylight savings times, because the selected status is displayed on the screen as the status displaying symbol 51 of the operating symbol 50.

In this way, in the present embodiment, the detection times from the historic data obtained from the server device 10 is converted into second standard times and daylight savings times by the client terminal 20, and a time series is displayed on the screen based on either the first standard times, the second standard times, or the daylight savings times, while, additionally, either the second standard times or daylight savings times are selected by an operation to be displayed on the screen together with the process data.

More specifically, when a time series of event data included in the process data based on the historic data is displayed on the screen, either the second standard times or daylight savings times, selected through an operation, are displayed on the screen as the event occurrence times for the events.

Because of this, in contrast to the case wherein a time series is displayed on the screen using the adjusted times, there will be no temporal blank spaces or overlapping in the display of the process data at the points in time P and Q wherein there is switching between daylight savings times and non-daylight savings times. Consequently, in the case of operations wherein there is switching, in particular, between daylight savings times and non-daylight savings times (standard times), the process data will be displayed on the screen in an easily understood manner, making it possible to prevent misunderstanding by the operator who is performing the process monitoring.

Additionally, in the present form of embodiment, an operating symbol 50 for selecting either the second standard times or the daylight savings times is displayed on the screen together with the process data, and either the second standard times or the daylight savings times are selected using the operating symbol 50 to be displayed on the screen together with the process data, thus making it possible for the operator to switch the display, and to confirm the switching, between the second standard times and the daylight savings times through an extremely simple operation, and also possible to prevent misunderstanding by the operator.

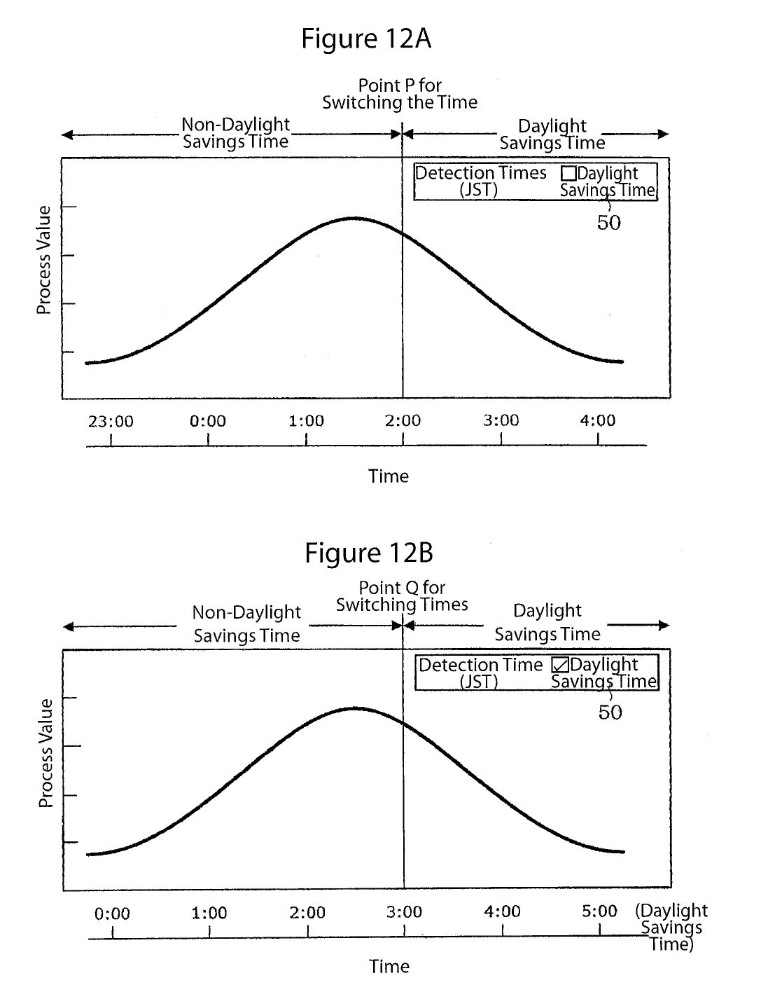

Furthermore, while, in the present form of embodiment, a case wherein the process data consisted of event data was explained as an example, the type of process data is not limited thereto, but may instead be process values. FIG. 12 is an example of a screen display of a trend graph when switching to daylight savings times as set forth in an embodiment according to the present invention. Normally, when displayed as a time series, the process data is displayed on the screen as a trend graph as illustrated in FIG. 12. Consequently, either the second standard times or the daylight savings times corresponding to the first standard times may be added to the time axis of the trend graph and displayed as the detection times corresponding to each event data (process value)by the display controlling portion 26. Additionally, the operating symbol 50 may also be displayed on the screen in addition to the process data, as in FIG. 10 and FIG. 11.

Specifically, FIG. 12(a) illustrates an example of a screen display of a trend graph that uses non-daylight savings times, where a non-selected state, wherein no checkmark or black circle has been added, is displayed on the screen as the status displaying symbol 51 of the operating symbol 50. Additionally, the time axis 53 that that shows the second standard times (non-daylight savings times) is displayed on the screen as the time axis.

FIG. 12(b) illustrates an example of a screen display of a trend graph that uses daylight savings times, where a selected state, wherein a checkmark or black circle has been added, is displayed on the screen as the status displaying symbol 51 of the operating symbol 50. Additionally, the time axis 54 that that shows the daylight savings times is displayed on the screen as the time axis.

While a case wherein the first standard times and the second standard times are different was explained above as an example, the first standard times and the second standard times may be identical standard times, as mentioned above, and in this case, processing may be performed with the standard time differential=0 or with the first standard times being used as-is as the second standard times.

That is, when client terminals 20 are disposed over a wide range of regions in the process monitoring system 100 according to the present invention, naturally one may envision the client terminals each using its own second standard times. However, for the case of a local process monitoring system, then both the server device 10 and the client terminal 20 may have a single standard time. Such a form of embodiment should be understood to be included within the scope of the present invention.

Additionally, in a small-scale process monitoring system there may be a case wherein the functions of both the server device and the client terminal are provided in a single device in a stand-alone form of embodiment, and such a form of embodiment should be understood to be within the scope of the present invention.

1. A process monitoring system comprising:
a server device and a client terminal connected through a communications network, wherein process data collected from field devices by the server device are obtained by the client terminal through the communications network to be displayed on a screen,
wherein the server device comprises:
a standard time clock portion timing first standard times;
a data receiving portion receiving the process data from the field devices and receiving the first standard times that indicate the detection times for the process data, from the standard time clock portion, and storing historic data, comprising combinations of these process data and first standard times, into a historic database; and
a data providing portion reading out the historic data from the historic database and
providing notification to the client terminal through the communications network; and
wherein the client terminal comprises:
a data receiving portion receiving the historic data through the communications network from the server device;
a time controlling portion converting the first standard times that are included in the historic data received by the data receiving portion into second standard times that are used by the client terminal, and converting the second standard times into daylight savings times that are shifted by a specific amount of time; and
a display controlling portion displaying on a screen displaying portion the process data included in the historic data received by the data receiving portion, chronologically based on the first standard times, or on the second standard times or daylight savings times that are converted by the time controlling portion, and displaying at least one of the second standard times and the daylight savings times, that has been selected through an operation, on a screen together with the process data by the screen displaying portion.

2. A process monitoring system as set forth in claim 1, wherein:
the display controlling portion, when displaying a graph of the trend in the process values included in the process data based on the historic data, displays either both a time axis comprising the second standard times and a time axis comprising the daylight savings times, or one of the time axes selected through an operation, as the time axis for the graph.

3. A process monitoring system as set forth in claim 1, wherein:
the display controlling portion, when displaying a time series of event data included in the process data based on the historic data, displays at least one of the second standard times and the daylight savings times, selected through an operation, as the event occurrence times of the events.

4. A process monitoring system as set forth in claim 1, wherein:
the display controlling portion displays an operating symbol selecting either the second standard times or the daylight savings times on a screen together with the process data, and displays, together with the process data, either the second standard times or the daylight savings times, selected by the operating symbol.

5. A process monitoring method comprising a server device and a client terminal connected through a communications network, wherein process data collected from field devices by the server device are obtained by the client terminal through the communications network to be displayed on a screen,
wherein the server device performs the steps of:
timing first standard times in a standard time clock step;
receiving the process data, in a data receivingreceiving step from the field devices, the first standard times that indicate the detection times for the process data, from the standard time clock step, and storing historic data, comprising at least one of these process data and first standard times, into a historic database; and
reading out the historic data from the historic database and providing notification to the client terminal through the communications network in a data providing step; and
whereinthe client terminal performs the steps of:
receiving the historic data through the communications network from the server device in a data receiving step;
converting the first standard times that are included in the historic data received by the data receiving step into second standard times that are used by the client terminal, and converting the second standard times into daylight savings times that are shifted by a specific amount of time in a time controlling step; and
displaying on a screen displaying portion the process data included in the historic data received by the data receiving step, chronologically based on the first standard times, or on the second standard times or daylight savings times that are converted by the time controlling portion, and for displaying at least one of the second standard times and the daylight savings times, that has been selected through an operation, on a screen together with the process data by the screen displaying portion in a display controlling step.
